(19) United States
(12) Patent Application Publication
(10) Pub. No.: US 2012/0054694 A1
(43) Pub. Date: Mar. 1, 2012

(54) Aerial Image Signatures

(76) Inventor: Ayman YEHIA HAMOUDA, Fishkill, NY (US)

(21) Appl. No.: 13/018,075

(22) Filed: Jan. 31, 2011

Related U.S. Application Data
(60) Provisional application No. 61/376,651, filed on Aug. 24, 2010.

(51) Int. Cl. G06F 17/50

(52) U.S. Cl. 716/53

(57) ABSTRACT

Aerial image signatures may be constructed with some combinations of aerial image parameters such as the maximum intensity, the minimum intensity, the image contour curvature, and the intensity profile slope. Aerial image signatures may be applied to lithographic processes for identifying/processing non-litho friendly areas in a design layout.

### RELATED APPLICATIONS

This application claims priority to U.S. Provisional Patent Application No. 61/376,651, entitled “Aerial Image Signatures,” filed on Aug. 24, 2010, and naming Ayman Yehia Hamouda as inventor, which application is incorporated entirely herein by reference.

### FIELD OF THE INVENTION

The present invention is directed to semiconductor manufacturing. Various aspects of the invention may be particularly useful for applying aerial image signatures to photolithography.

### BACKGROUND OF THE INVENTION

Electronic circuits, such as integrated circuits (ICs), are used in a variety of products, from automobiles to microwaves to personal computers. Designing and fabricating IC devices typically involves many steps, sometimes referred to as the “design flow.” The particular steps of a design flow often are dependent upon the type of the circuit, its complexity, the design team, and the circuit fabricator or foundry that will manufacture the circuit. Typically, software and hardware “tools” verify the design at various stages of the design flow by running software simulators and/or hardware emulators. These steps aid in the discovery of errors in the design, and allow the designers and engineers to correct or otherwise improve the design.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing IC components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

Circuit layout descriptions can be provided in many different formats. The Graphic Data System II (GDSII) format is a popular format for transferring and archiving two-dimensional (2D) graphical circuit layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in design layouts that are employed to manufacture integrated circuits. Once the design is finalized, the layout portion of the design can be used by fabrication tools to manufacture the circuit using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in a design layout define the relative locations or areas of the circuit that will be exposed to radiation through the mask. A mask or reticle writing tool is used to create the mask based upon the design layout, after which the mask can be used in a photolithographic process.

As designers and manufacturers continue to increase the number of circuit components in a given area and/or shrink the size of circuit components, the shapes reproduced on the substrate (and thus the shapes in the mask) become smaller and are placed closer together. This reduction in feature size increases the difficulty of faithfully reproducing the image intended by the design layout onto the substrate. The diffractive effects of light often result in defects where the intended image is not accurately “printed” onto the substrate during the photolithographic process, creating flaws in the manufactured device. One or more resolution enhancement techniques (RETs) are often employed to improve the resolution of the image that the mask forms on the substrate during the photolithographic process. Examples of various resolution enhancement techniques are discussed in “Resolution Enhancement Technology: The Past, the Present, and Extensions for the Future,” Frank M. Schellenberg, Optical Microlithography XVII, edited by Bruce W. Smith, Proceedings of SPIE Vol. 5377, which article is incorporated entirely herein by reference. One of these techniques, “optical proximity correction” or “optical process correction” (OPC), adjusts the amplitude of the light transmitted through a lithographic mask by modifying the design layout data employed to create the mask. For example, edges in the design layout may be adjusted to make certain portions of the geometric elements larger or smaller, in accordance with how much additional light exposure (or lack of exposure) is desired at certain points on the substrate. When these adjustments are appropriately calibrated, overall pattern fidelity is greatly improved.

Even with the application of RETs, some layout regions may still have printability issues. These regions are called lithography hotspots or litho hotspots. Litho hotspots can only be corrected by modifying design layouts in such a manner as to cause a change in the final printed contours. For example, pinching hotspots require an increase of the width of a printed contour subject to pinching while bridging hotspots requires an increase of the spacing between two printed contours subject to bridging. The layout modification procedure may be performed by either manufacturers or designers. As for the former, the procedure is sometimes referred to as retargeting since it involves the adjustment of drawn shapes to serve as targets for eventual wafer contours. While OPC and process window simulation can be used to guide the retargeting, that approach is expensive and time consuming. It is desirable to explore new techniques that can locate hotspots and modify design layouts more efficiently. As for the latter, the layout modification procedure is often included in a design for manufacture (DFM) technology known as litho-friendly design (LFD). LFD enables a layout designer to predict the effects of process variations on the printability of a specific design and then to adjust the design accordingly. Thus, it is also beneficial to develop an efficient means for identifying non-litho-friendly areas and providing repair hints.

### BRIEF SUMMARY OF THE INVENTION

Aspects of the invention relate to applying aerial image signatures to photolithography. In various embodiments of the invention, aerial image signatures may include any combinations of maximum, minimum intensities (Iₘₐₓ and Iₘᵢₙ), the aerial image contour curvature (curvature), the slope of the aerial image intensity profiles (slope) and other aerial image parameters. The aerial image signature values for layout features may be obtained by performing optical simulation on layouts. The aerial image signature values may be used to identify non-litho-friendly layout areas, such as litho hotspots, and to modify layouts accordingly.

In various embodiments of the invention, an aerial image signature model is created for the application of aerial image signatures using one or more calibration layouts. The one or more calibration layouts may be either generated by a layout generation tool or extracted from existing design layouts. Lithography simulations may be performed on the one or more calibration layouts to predict printed contours. Using the predicted printed contours, layout areas having a predefined property (e.g. non-litho-friendly layout areas) may be identified and data related to the predefined property may be extracted. The aerial image signature values for these layout areas may be obtained by optical simulation. An aerial image signature model may then be created by mapping the data related to the predefined property to the aerial image signature values. The created model can be used for detecting layout areas having the predefined property in a design layout. The model may also establish the relationship between the edge movement information and the aerial image signature values for modifying layout purposes.

Aerial image signatures may be applied to, among others, retargeting, LFD and double dipole lithography (DDL). In retargeting, layout designs may be modified to produce more litho-friendly OPC targets based on aerial image signature values. In LFD, an aerial image signature model may be incorporated into LFD tools to help designers to identify hotspots and to provide them with repair hints. In DDL, aerial image signatures may be used to assist in layout decomposition.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 illustrates an example of an aerial image signature model creation tool and an example of an aerial image signature application tool.

FIG. 4a illustrates a flowchart describing methods of creating an aerial image signature model; FIG. 4b illustrates a flowchart describing methods of applying aerial image signatures.

FIG. 5 presents a table showing constant image contrast values cover three layout areas with different levels of printability (the first column is Iₘᵢₙ, the first row is Iₘₐₓ).

FIG. 6 illustrates worst width contours in an Iₘₐₓ−Iₘᵢₙ map.

FIG. 7 displays a table of the worst widths vs. the Iₘₐₓ−Iₘᵢₙ values.

### DETAILED DESCRIPTION OF THE INVENTION

Various aspects of the present invention relate to applying aerial image signatures to photolithography. In the following description, numerous details are set forth for the purpose of explanation. However, one of ordinary skill in the art will realize that the invention may be practiced without the use of these specific details. In other instances, well-known features have not been described in details to avoid obscuring the present invention.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “derive,” “generate” and “create” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “layout” is intended to encompass data describing an entire integrated circuit device. This term also is intended to encompass a smaller group of data describing one or more components of an entire device, however, such as a portion of an integrated circuit device. Still further, the term “layout” also is intended to encompass data describing more than one microdevice, such as data to be used to form multiple microdevices on a single wafer.

### Operating Environment

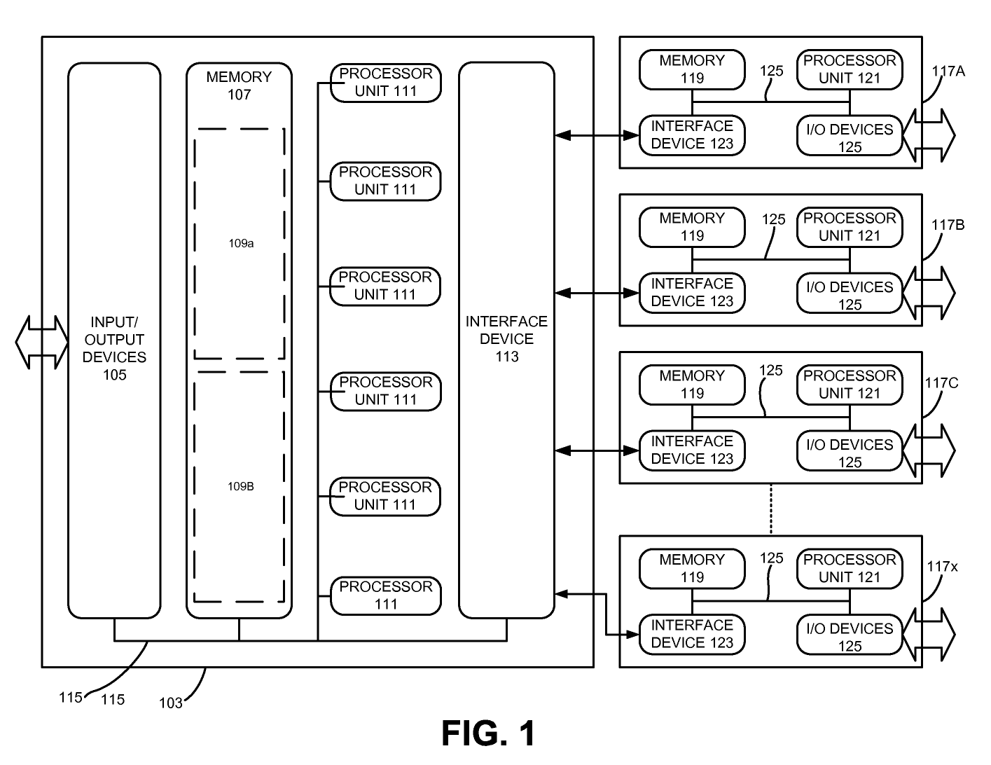

The execution of various electronic design automation processes may be implemented using computer-executable software instructions executed by one or more programmable computing devices. Because these examples of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or slave computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

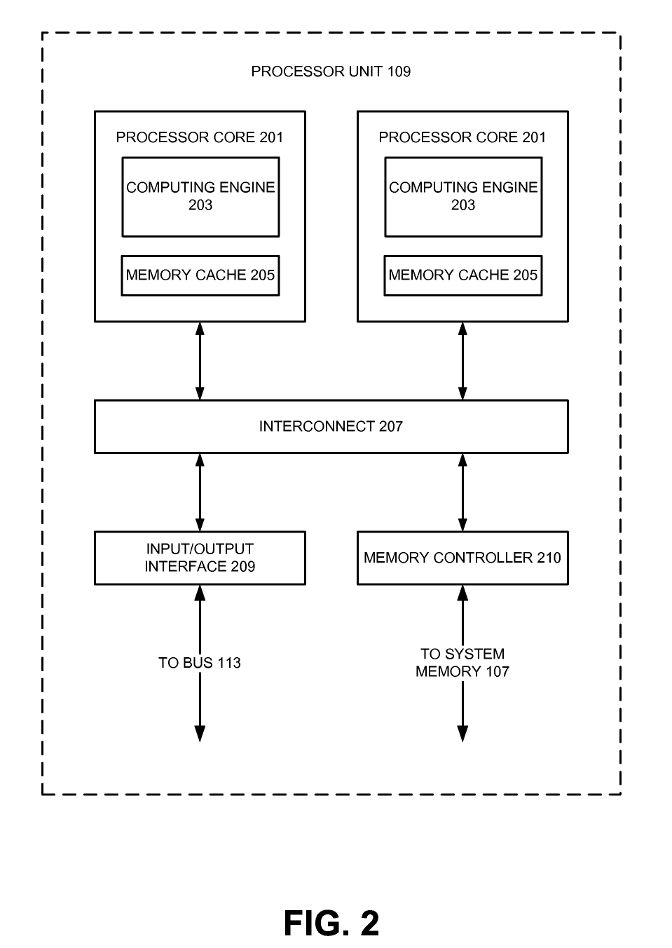

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the slave computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 122, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the invention may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers, it should be noted that, with alternate embodiments of the invention, either the computer 103, one or more of the slave computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Aerial Image Signatures

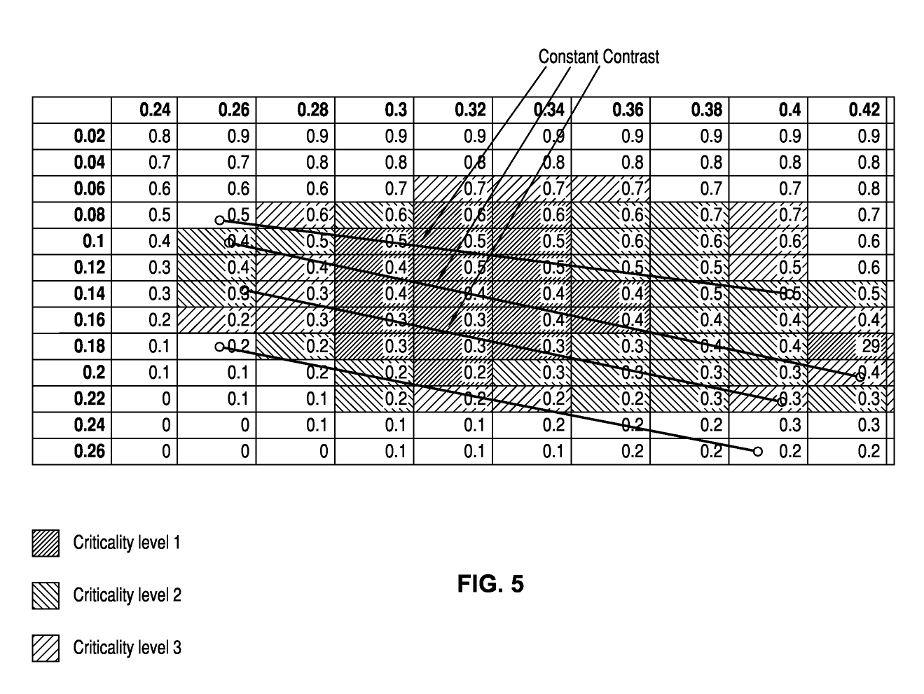

Projection imaging tools, such as scanners, steppers, or step-and-scan tools, project an image of a mask pattern into air, and then ultimately into the photoresist. The aerial image is the mask image projected onto the plane of the photoresist-coated wafer but assuming that only air occupies this space rather than the phtotoresist-coated wafer. The aerial image shows a distribution of light intensity as a function of spatial position within (or near) the image plane. The quality of the aerial image dictates the quality and controllability of the final resist profile—the printed image. Accordingly, aerial image parameters may be used to predict printability. The classic metric of the aerial image quality is image contrast. However, this aerial image parameter alone may not be sufficient for identifying non-litho-friendly areas. In FIG. 5, the first row is Iₘₐₓ, the first column is Iₘᵢₙ, and the rest are corresponding image contrast values. Evidently from the figure, several contrast values cover three regions with different levels of printability, indicated by three different shadings.

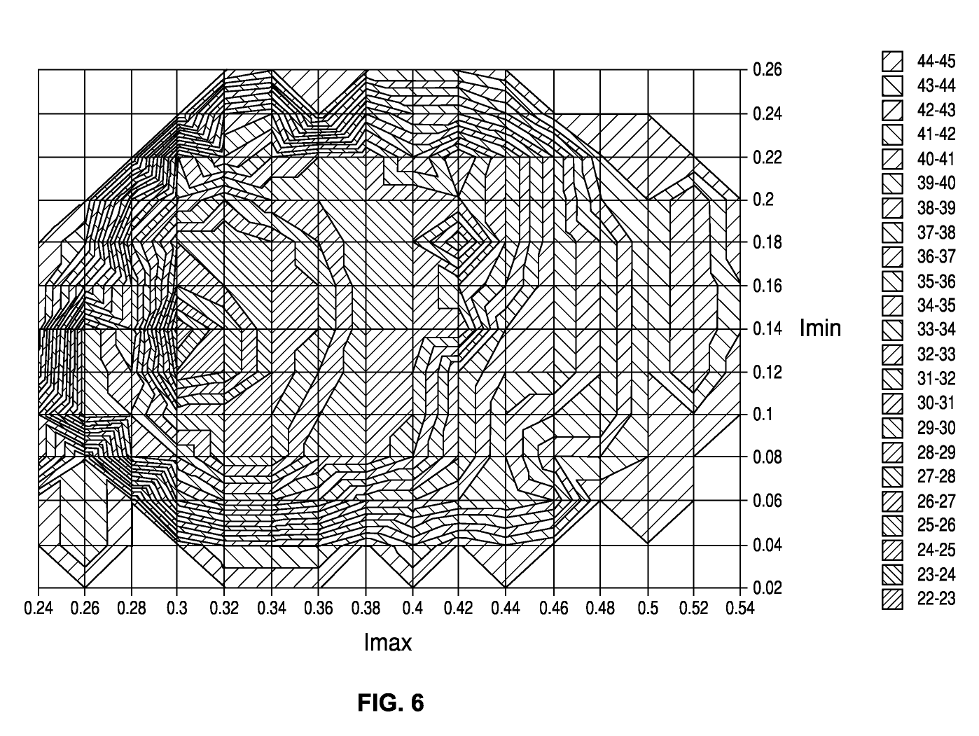

Various combinations of aerial image parameters, such as the Iₘₐₓ and Iₘᵢₙ pair, may serve as printability indicators and be used to locate non-litho-friendly areas. These various combinations of aerial image parameters are referred hereafter to as aerial image signatures. FIG. 6 shows the worst width contours with Iₘₐₓ and Iₘᵢₙ being the horizontal and vertical axes, respectively. The worst width stands for the narrowest width of a printed layout feature that can be reached in a process window. It may be derived by calculating process-variation bands, which represent possible locations of printed contours under various process window conditions. In the figure, the worst width contours form closed loops and follow essentially a monotonic behavior. Two “valley” regions are formed where the worst widths reach 22-23 nm and 29-30 at the bottom, respectively. This pattern suggests the values of the Iₘₐₓ and Iₘᵢₙ pair (the aerial image signature values) may be used for predicting the worst widths and thus for locating pinching hotspots. For example, if the Iₘₐₓ and Iₘᵢₙ values of a layout region are in the two “valley” areas, the layout region is suspect to pinching.

Aerial image signatures may include other aerial image parameters, such as the aerial image contour curvature and the aerial image intensity slope. Aerial images signatures may also be constructed by various combinations of aerial image parameters. For example, the aerial image signature consisting of Iₘₐₓ, Iₘᵢₙ and curvature may be better indicators of printability than that of Iₘₐₓ and Iₘᵢₙ alone due to the addition of a third aerial image parameter. It should be appreciated that aerial image signatures may be used as indicators of other properties related to printed images in addition to printability.

### Aerial Image Signature Tools

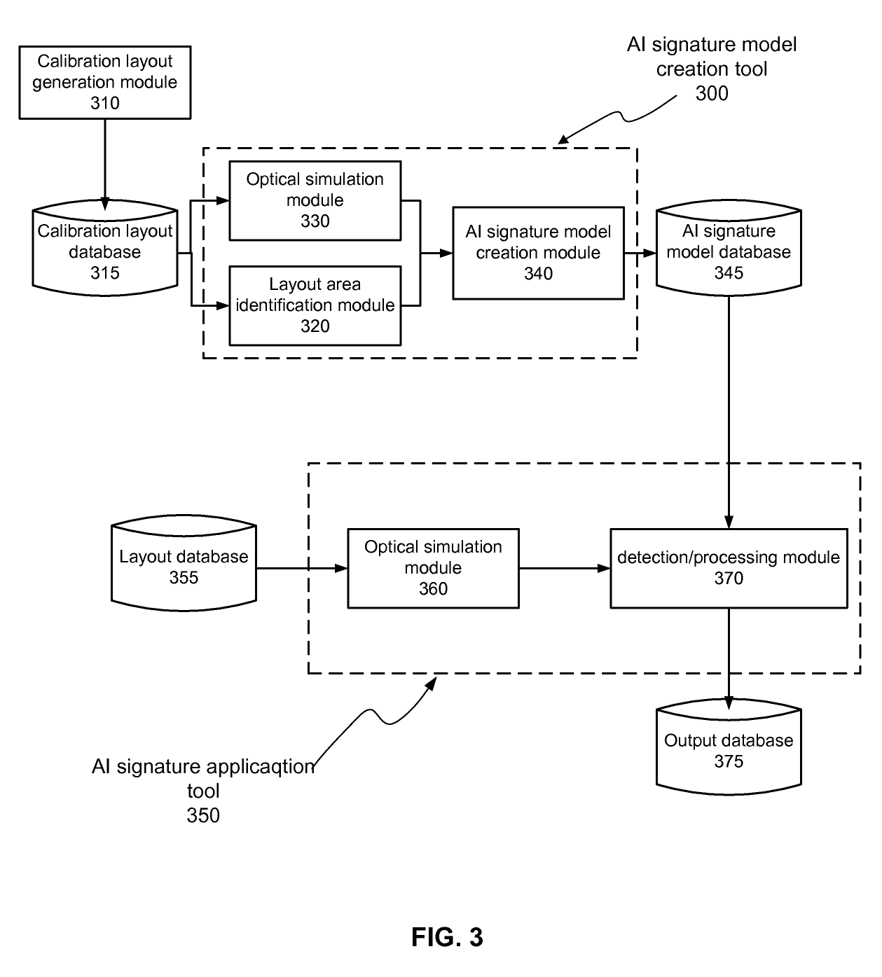

FIG. 3 illustrates an example of two aerial image signature-based tools, an AI (aerial image) signature model creation tool 300 and an AI signature application tool 350, that may be implemented according to various embodiments of the invention. As seen in the figure, the model creation tool 300 includes an optical simulation module 330, a layout area identification module 320, and an AI signature model creation module 340; and the application tool 350 includes an optical simulation module 360 and a detection/processing module 370. As also shown in this figure, various implementations of the model creation tool 300 may cooperate with (or incorporate, in whole or part) a calibration layout generation module 310, a calibration layout database 315 and an AI signature model database 345; and various implementations of the application tool 300 may cooperate with (or incorporate, in whole or part) a layout database 355, the AI signature model database 345 and an output database 375.

As will be discussed in detail below, the model creation tool 300 may use calibration layouts stored in the calibration layout database 315 to create models for identifying layout areas having a predefined property (e.g. non-litho-friendly areas) and in some applications, for modifying layout features in the identified layout areas. The calibration layouts are layouts with areas having the predefined property. They may be prepared by the calibration layout generation module 310 using various methods. One method is extracting layout portions from existing design layouts. Another method is using a place and route tool or an automatic layout generation tool to generate layouts for model creation. The two methods may be combined together or with other methods. Once the calibration layouts are obtained, the calibration layout generation module 310 stores them in the calibration layout database 315.

The layout area identification module 320 receives one or more calibration layouts from the database 315 for model creation. Using various traditional methods, the module 320 may then identify regions in the one or more calibration layouts that have the predefined property and extract data related to the predefined property if the database 315 does not provide such information. The optical simulation module 330 uses optical simulation to derive aerial image signature values for layout features in the identified layout areas.

With the data related to the predefined property and the aerial image signature values, the model creation module 340 creates an aerial image signature model by establishing the relationship between the aerial image signatures and the predefined property. For example, the module 340 may generate a graph showing worst width contours like the one in FIG. 6. The graph shows the relationship between the values of Iₘₐₓ and Iₘᵢₙ and pinching hotspots. The module 340 may additionally or alternatively generate a table for such purposes. Moreover, the module 340 may derive the relationship between edge movement information for a predefined purpose (e.g. retargeting) and the aerial image signature values. The relationship may be reflected in a lookup table, an equation or any other appropriate forms. Finally, the module 340 saves the created aerial image signature model in the AI signature model database 345.

After an aerial image signature model is created, the aerial image signature application tool 350 may apply it to various processes such as retargeting, LFD and DDL. It should be noted that the above list of processes is neither exclusive nor exhaustive. Like the module 330, the optical simulation module 360 derives the aerial image signature values by performing optical simulation on a design layout received from the layout database 355. With the derived aerial image signature values and the aerial image signature model received from the AI signature model database 345, the detection/processing module 370 may identify areas in the design layout that have the predefined property associated with the aerial image signature model (e.g. non-litho friendly areas). Depending on the applications, the module 370 may also modify the design layout (e.g. retargeting) or providing edge movement information to users (e.g. LFD) according to the aerial image signature model. The output data may be stored in the output database 375.

As previously noted, various embodiments of the invention may be embodied by a computing system, such as the computing system illustrated in FIG. 1 and FIG. 2. Accordingly, one or more components of each of the calibration layout generation module 310, the optical simulation module 330, the layout area identification module 320, the AI signature model creation module 340, the optical simulation module 360 and the detection/processing module 370 may be implemented using one or more processors in a computing system. It should be appreciated that, while these six modules are shown as separate units in FIG. 3, a single computer (or a single processor in a computing system) may be used to implement two or more of these modules at different times. Also, various examples of the invention may be embodied by software-executable instructions, stored on a computer-readable medium, for instructing a computing system to implement one or more components of each of the calibration layout generation module 310, the optical simulation module 330, the layout area identification module 320, the AI signature model creation module 340, the optical simulation module 360 and the detection/processing module 370. Further, while the calibration layout database 315, the AI signature model database 345 and the output database 375 are shown as separate units in FIG. 3, a single computer accessible medium may be used to implement two or all three of these databases. Still further, each module may either be fully automated or allow a user to provide instructions for an operation.

### Aerial Image Signature Model Creation

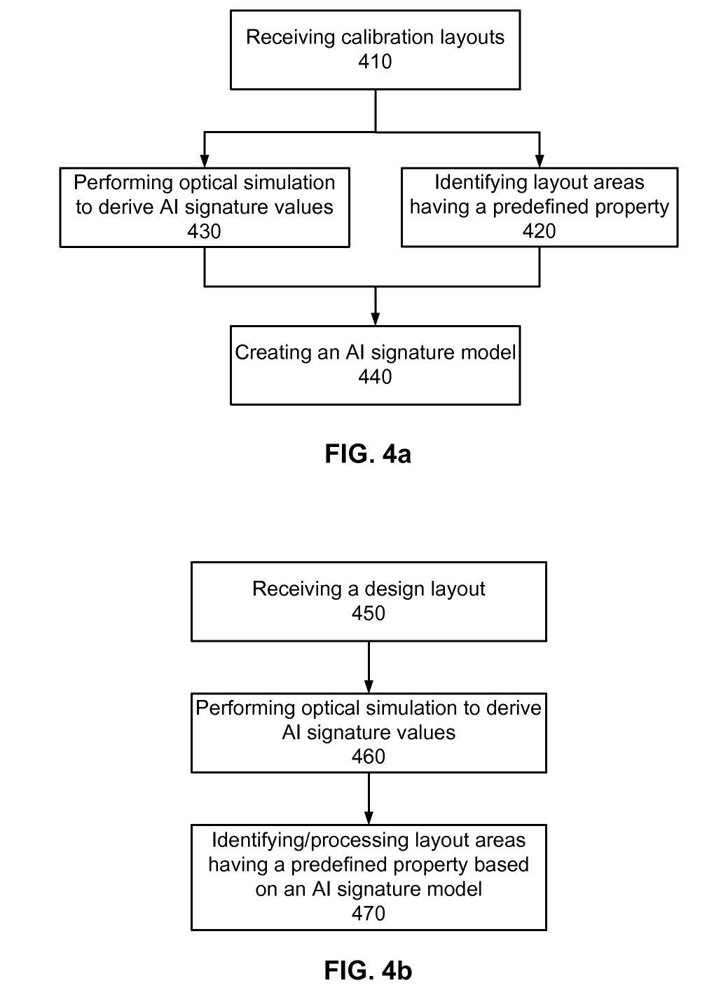

FIG. 4a illustrates a flowchart describing methods of aerial image signature model creation according to various embodiments of the invention. For purposes of explanation, various methods encompassed in FIG. 4a will be described with reference to the AI signature model creation tool 300 shown in FIG. 3. It should be appreciated that the operations illustrated in FIG. 4a may be employed by implementations of a different AI signature model creation tool, according to various embodiments of the invention. Likewise, it should be appreciated that the AI signature model creation tool 300 shown in FIG. 3 may be used to perform model creation methods according to various embodiments of the invention different from those encompassed by the flowchart of FIG. 4a.

Also, it should be appreciated that various embodiments of the invention may be implemented by a system comprising one or more processors programmed to perform the operations described in FIG. 4a. Still further, various embodiments of the invention may be implemented by processor-executable instructions, stored in a processor-readable medium, for causing one or more processors to perform the operations described in FIG. 4a.

The flow illustrated in FIG. 4a starts with operation 410, receiving calibration layouts by the model creation tool 300. As discussed in the previous section, one or more calibration layouts may be used for creating an aerial image signature model. The one or more calibration layouts should contain regions having a predefined property. One class of such calibration layouts are layouts containing non-litho-friendly areas. To create aerial image signature models for the retargeting or LFD applications, for example, various kinds of litho hotspots need to be found in the one or more calibration layouts. With some implementations of the invention, the calibration layout generation module 310 may employ a place and route tool or an automatic layout generation tool to generate the calibration layouts. Alternatively or additionally, the calibration layout generation module 310 may use a layout extraction tool to extract layout portions containing regions with the predefined property from an existing design layout to serve as calibration layouts. These tools for generating calibration layouts are commercially available, such as those in the CALIBRE family of software tools available from Mentor Graphics Corporation, Wilsonville, Oreg., and may be incorporated in or otherwise employed by the calibration layout generation module 310 for the extraction purpose.

In operation 420, the layout area identification module 320 identifies layout areas having the predefined property in the received one or more calibration layouts if such information is not available yet. In some embodiments of the invention, the layout area identification module 320 may first apply OPC to the calibration layouts and then use process window simulation to generate process-variation bands. Based on the process-variation bands, areas having the predefined property such as litho hotspots may be readily identified. Moreover, data associated with the predefined property may be derived from the process-variation bands. For pinching hotspots, the data may include the worst width—the narrowest width that can be reached under various process window conditions, while for bridging hotspots, the data may include the worst spacing—the narrowest spacing that can be reached under various process window conditions. To perform the OPC and process window simulation processes, the layout area identification module 320 may employ various commercial tools including the tools in the CALIBRE family of software tools available from Mentor Graphics Corporation, Wilsonville, Oreg.

In operation 430, the optical simulation module 330 derives aerial image signature values using optical simulation. With various implementations of the invention, layout feature edges in the one or more calibration layouts are fragmented into edge fragments. A simulation site is then inserted around an edge fragment. The module 330 may perform optical simulation at the simulation site with a commercial tool (e.g. some simulation tools in the CALIBRE family) to generate aerial image information for the edge fragment. Depending on the kind of aerial image signatures used, values of Iₘₐₓ, Iₘᵢₙ, curvature, slope or other parameters may be extracted from the aerial image information.

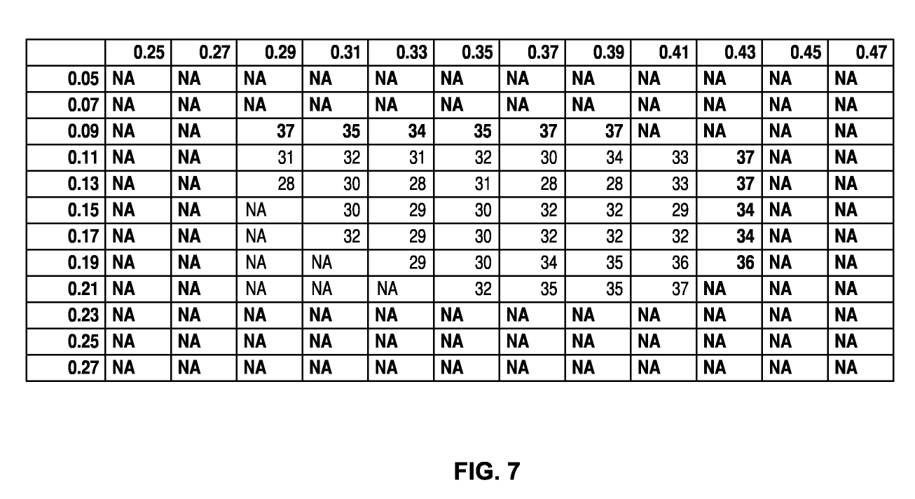

In operation 440, the AI signature model creation module 340 builds an aerial image signature model showing the relationship between the aerial image signature values and the data related to the predefined property. Various methods may be used to derive the relationship. One method is constructing contour diagram like the one in FIG. 6. In FIG. 6, the worst width contours are drawn against Iₘₐₓ and Iₘᵢₙ. Another method is building one or a series of tables. FIG. 7 displays such a table. The first row of the table shows Iₘₐₓ values, the first column shows Iₘᵢₙ values, and the rest of the table cells are the worst width values for the corresponding Iₘₐₓ and Iₘᵢₙ values (only the values of the worst widths near pinching hotspots are shown while the others are represented by “NA”). From either the contour diagram in FIG. 6 or the table in FIG. 7, the Iₘₐₓ and Iₘᵢₙ values corresponding to pinching hotspots are easy to be identified and may be used for detecting hotspots in a design layout.

For applications that need to process the identified layout areas, the AI signature model creation module 340 also establishes the relationship between the edge movement information needed for the processing and the aerial image signature values. The edge movement information may be obtained heuristically or by traditional methods. The model creation module 340 may map the edge movement information to the aerial image signature values and show the relationship with a lookup table. Alternatively or additionally, the model creation module 340 may create a model by fitting the edge movement information and the aerial image signature values to an equation.

### Aerial Image Signature Application

FIG. 4b illustrates a flowchart describing methods of aerial image signature application according to various embodiments of the invention. For purposes of explanation, various methods encompassed in FIG. 4b will be described with reference to the AI signature application tool 350 shown in FIG. 3. It should be appreciated that the operations illustrated in FIG. 4b may be employed by implementations of a different AI signature application tool, according to various embodiments of the invention. Likewise, it should be appreciated that the AI signature application tool 350 shown in FIG. 3 may be used to perform aerial image signature application methods according to various embodiments of the invention different from those encompassed by the flowchart of FIG. 4b.

Also, it should be appreciated that various embodiments of the invention may be implemented by a system comprising one or more processors programmed to perform the operations described in FIG. 4b. Still further, various embodiments of the invention may be implemented by processor-executable instructions, stored in a processor-readable medium, for causing one or more processors to perform the operations described in FIG. 4b.

The flow illustrated in FIG. 4b starts with operation 450, receiving a design layout by the application tool 350. In operation 460, the optical simulation module 360 in the tool 350 performs optical simulation on the received design layout and derives aerial image signature values for layout features in the design layout. The optical simulation module 360 works in a similar way as the optical simulation module 330 in the tool 300 does. With various implementations of the invention, edges of the layout features are fragmented into edge fragments. A simulation site is inserted for each edge fragment. The module 360 then performs optical simulation on the simulation sites to derive aerial image signature values for the edge fragments.

In operation 470, the detection/processing module 370 applies the derived aerial image signature values to a lithographic process. The application is based on an aerial image signature model for the lithographic process. This model may be generated by the model creation tool 300, as discussed in the previous section. Aerial image signatures may be applied to various processes including retargeting, LFD and DDL. In retargeting, the aerial image signature model provides edge movement data for edge fragments in the design layout for the aerial image signature values. The detection/processing module 370 retargets the design layout using the edge movement data. In LFD, the aerial image signature model provides the location information of litho hotspots and repair hints (edge movement data) for the litho hotspots to layout designers.

DDL, a double exposure technique, has been developed to increase image resolution. In DDL, a design layout is decomposed into two layout portions, corresponding to two dipole light sources with orthogonal dipole orientations. The detection/processing module 370 may conduct a retargeting process before or after the layout decomposition. The detection/processing module 370 may also identify, with the aid of the aerial image signature model and the aerial image signature values, layout areas that are difficult to print but are assigned to only one layout portion by traditional decomposition methods. To increase the printability, these identified layout areas may be assigned to both the layout portions so as to be exposed by both the dipole light sources.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of aerial image signature model generation, comprising:
receiving layout data for one or more calibration layouts;
identifying layout areas having a predefined property in the one or more calibration layouts;
performing optical simulation to derive values of aerial image signature for the layout areas;
generating an aerial image signature model associated with the predefined property based on the values of the aerial image signatures for the layout areas; and
storing data for the aerial image signature model in a processor-accessible medium.

2. The method recited in claim 1, wherein one of the one or more calibration layouts is generated using an automatic layout generation tool.

3. The method recited in claim 1, wherein one of the one or more calibration layouts is extracted from a design layout.

4. The method recited in claim 1, wherein the layout areas having a predefined property include non-litho-friendly areas.

5. The method recited in claim 1, wherein the non-litho-friendly areas are litho hotspots.

6. The method recited in claim 1, wherein the identifying comprises:
performing simulation on the one or more calibration layouts to generate process-variation bands; and
identifying layout areas having a predefined property based on the process-variation bands.

7. The method recited in claim 6, wherein the performing simulation on the one or more calibration layouts comprises:
applying one or more resolution-enhancement technologies (RETS) to the one or more calibration layouts to obtain one or more modified calibration layouts; and
performing simulation on the one or more modified calibration layouts to generate process-variation bands.

8. The method recited in claim 1, wherein the aerial image signatures include two or more parameters selected from the group consisting of Iₘₐₓ, Iₘᵢₙ, curvature, and slope.

9. The method recited in claim 1, wherein the performing optical simulation comprises:
fragmenting edges in the layout areas into edge fragments;
determining simulation sites for the edge fragments; and
performing optical simulation for the simulation sites to derive values of the aerial image signatures for the edge fragments.

10. The method recited in claim 1, wherein the generating comprises:
identifying threshold values or value ranges for the aerial image signatures associated with the predefined property.

11. The method recited in claim 1, wherein the generating further comprises:
determining, for a predefined purpose, edge movement information for the values of the aerial image signatures.

12. The method recited in claim 11, wherein the predefined purpose is repairing litho hotspots.

13. The method recited in claim 11, wherein the determining comprises building a lookup table showing relationship between the edge movement information and the values of the aerial image signatures.

14. The method recited in claim 11, wherein the determining comprises deriving an equation showing relationship between the edge movement information and the values of the aerial image signatures.

15. A method of applying areal image signatures, comprising:
receiving layout data for a design layout;
performing optical simulation to derive values of aerial image signatures for the design layout; and
searching for one or more layout areas having a predefined property in the design layout using an aerial image signature model associated with the predefined property and the values of the aerial image signatures.

16. The method recited in claim 15, further comprising:
processing the one or more layout areas having the predefined property based on the aerial image signature model associated with the predefined property.

17. The method recited in claim 16, wherein the processing includes retargeting the design layout.

18. The method recited in claim 16, wherein the processing includes generating repair hints for the one or more layout areas having the predefined property.

19. The method recited in claim 16, wherein the processing includes adjusting decomposition of the design layout for double dipole lithography.

20. The method recited in claim 15, wherein the one or more layout areas having a predefined property are litho hotspots.

21. The method recited in claim 15, wherein the aerial image signature model is in a lookup table form.

22. The method recited in claim 15, wherein the aerial image signature model is in an equation form.
